(19) United States
(12) Patent Application Publication
(10) Pub. No.: US 2006/0200554 A1
(43) Pub. Date: Sep. 7, 2006

(54) SYSTEM AND METHOD FOR PROMPTING UNNORMAL STATUSES OF AN OPERATION SYSTEM

(76) Inventors: Cheng-Yin Shen, Shenzhen (CN); Tzu-Chiang Peng, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,045

(22) Filed: Dec. 14, 2005

(30) Foreign Application Priority Data
Dec. 29, 2004 (CN) 200410091913.5

(51) Int. Cl. G06F 15/173

(52) U.S. Cl. 709/224

(57) ABSTRACT

A system for prompting unnormal statuses of an operation system includes a HTTP server (1). The HTTP server includes: a request receiving module (10) for receiving requests for reading an administration interface of web page; a detecting module (11) for detecting an operation system and determining whether any unnormal status exists in the operation system; an icon appending module (12) for appending an icon on the administration interface of the web page and for appending a link to the icon; a web page sending module (13) for sending the web page. A related method is also disclosed.

### FIELD OF THE INVENTION

The present invention relates to systems and methods for prompting unnormal statuses of an operation system.

### DESCRIPTION OF RELATED ART

A client-server (C/S) environment implies that an application is being jointly accomplished by two or more interdependent pieces of equipment, including software, hardware and interface. Generally, multiple clients connected to a server via an intranet which is any network (i.e. LAN or WAN) that supports internet applications, such as hypertext transfer protocol (HTTP). An operation system of a computer acts as a HTTP server when the operation system itself supports HTTP and it is simultaneously supported by either a network attached storage (NAS), a storage area network (SAN), a direct-attached storage (DAS) or a network address translator (NAT). Normally, the HTTP server is connected with HTTP clients via a network. The network may be an intranet, an Internet, or any other suitable type of communications link. The HTTP clients provide browsers for administering the operation system.

The operation system of the computer often has some problems resulting in unnormal status indication. However, users of the computer normally cannot find the problems unless they enter a special administration interface of a web page. For example, the buzzer installed in the computer buzzes when some unnormal statuses exist. If a user is not near the computer, he/she cannot receive the prompt from the buzzer and cannot resolve the problem in time. Moreover, the computer needs to restart after it performs some setups. The updated setup becomes effective only when the computer is restarted. In real practice, the user may continue operating and may not restart the computer in time. Sometimes, the updated setup cannot be effective if the user forgets to restart the computer.

What is needed, therefore, is a system and method which can prompt unnormal statuses of an operation system automatically via appending color icons on an administration interface of a web page. Different appearances of the icons denote different unnormal statuses. With appending links to the icons, user chooses the icons to execute special functions or to open special web pages, wherein special functions and the special web pages include analysis and solution of the unnormal statuses.

### SUMMARY OF INVENTION

A system for prompting unnormal statuses of an operation system in accordance with a preferred embodiment includes a HTTP server. The HTTP server includes: a request receiving module for receiving a request for reading an administration interface of a web page, and for opening the administration interface of the web page; a detecting module for detecting an operation system and determining whether any unnormal status exists in the operation system; an icon appending module for invoking and appending a corresponding icon on the administration interface of the web page according to the unnormal status, and for appending a link to the icon; and a web page sending module for sending the web page.

A method for prompting unnormal statuses of an operation system in accordance with another preferred embodiment includes the steps of: receiving a request for reading an administration interface of a web page; opening the administration interface of the web page; detecting an operation system and determining whether any unnormal status exists; appending a corresponding icon on the administration interface of the web page according to the unnormal status if such unnormal status exists; appending a link to the icon, wherein the link points to a special web page or a special function; displaying color icon; sending the web page; choosing the icon and executing the special function or opening the special web page.

Other advantages and novel features of the present invention will become more apparent from the following detailed description of preferred embodiments when taken in conjunction with the accompanying drawings, in which:

### BRIEF DESCRIPTION OF DRAWINGS

FIG. 1 is a schematic diagram of hardware configuration of a system for prompting unnormal statuses of an operation system in accordance with a preferred embodiment of the present invention;

FIG. 2 is a schematic diagram of main software function modules of the HTTP server of FIG. 1;

FIG. 3 is a flowchart of a method for prompting unnormal statuses of an operation system in accordance with a preferred embodiment of the present invention.

### DETAILED DESCRIPTION

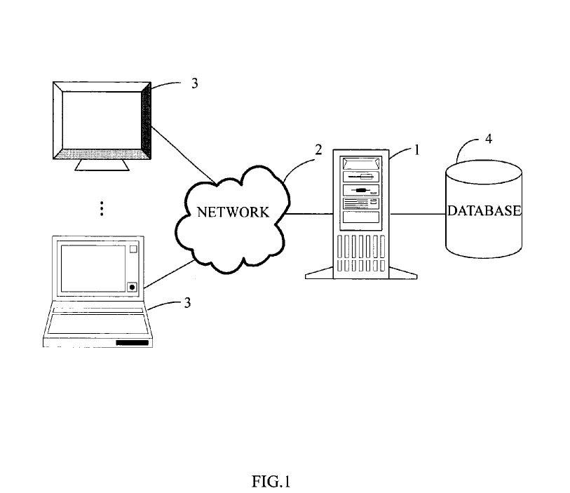

FIG. 1 is a schematic diagram of hardware configuration of a system for prompting unnormal statuses of an operation system (hereinafter, “the system”) in accordance with a preferred embodiment of the present invention. The system includes a HTTP (hypertext transfer protocol) server 1, a plurality of HTTP clients 2 (only two shown), and a database 4. The HTTP server 1 communicates with the HTTP clients 2 via a network 3. The HTTP server 1 is used for prompting unnormal statuses of an operation system by appending an icon on the web page, and for helping user to solve problems resulting in the unnormal statuses. The HTTP clients 2 are used for providing browser interface to administrators and users. The network 3 may be an intranet, an Internet, or any other suitable type of communications link. The HTTP server 1 is connected with the database 4 via a connection 5. The connection 5 is a database connectivity, such as an ODBC (Open Database Connectivity) or a JDBC (Java Database Connectivity). The database 4 is used for storing all kinds of icons, wherein each icon is corresponding to an unnormal status.

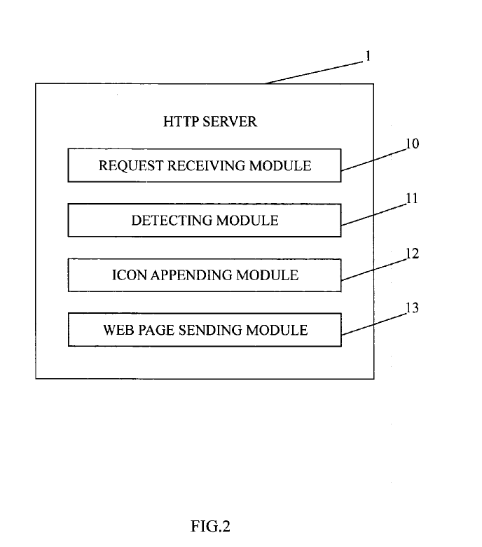

FIG. 2 is a schematic diagram of main software function modules of the HTTP server 1. The HTTP server 1 includes a request receiving module 10, a detecting module 11, an icon appending module 12 and a web page sending module 13.

The request receiving module 10 is used for receiving a request for reading an administration interface on a web page from HTTP clients 2, and for opening the corresponding administration interface of the web page. The detecting module 11 is used for detecting an operation system and determining whether any unnormal status exists in the operation system.

The icon appending module 12 is used for invoking a corresponding icon from the database 4 if an unnormal status exists in the operation system, and for appending the icon on the administration interface of the web page. The icon appending module 12 is further used for appending a link to the icon. The link points to a special function or a special web page, which can help the user to solve the problem resulting in the unnormal status. The web page sending module 13 is used for sending the web page appended the icon to the HTTP clients 2. The user receives the web page via the HTTP clients 2 and chooses the icon on the administration interface of the web page, and the icon appending module 12 executes the special function or the special web page to solve the problem resulting in the unnormal status.

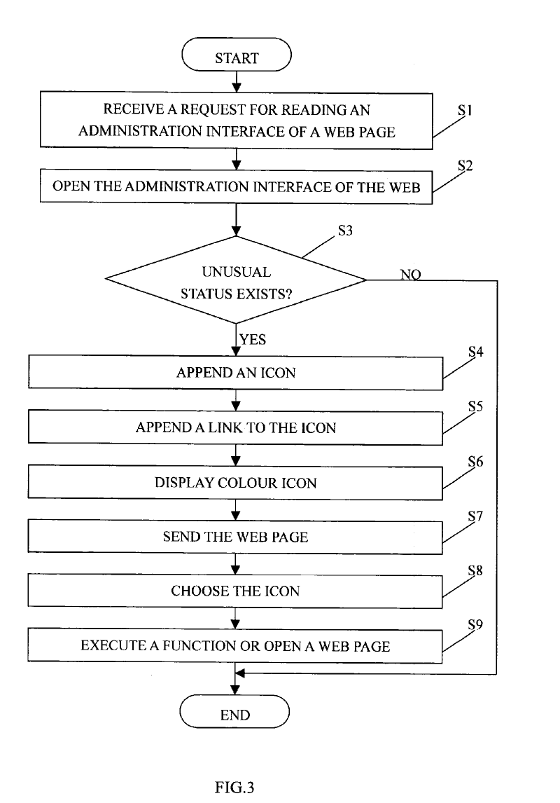

FIG. 3 is a flowchart of a method for prompting unnormal statuses of an operation system in accordance with a preferred embodiment of the present invention. In step S1, the request receiving module 10 receives a request for reading an administration interface of a web page from HTTP clients 2. In step S2, the request receiving module 10 opens the administration interface of the web page according to the received request. In step S3, the detecting module 11 detects an operation system and determines whether any unnormal status exists. If no unnormal status exists in operation system in step S3, the procedure ends.

If such unnormal status exists, in step S4, the icon appending module 12 appends a corresponding icon on the administration interface of the web page according to the unnormal status. In step S5, the icon appending module 12 appends a link to the icon, which points to a special function or a special web page. For example, the operation system needs to be restarted after changing some setups of the operation system. Then the icon appended on the administration interface of the web page has been linked to a special function for restarting the operation system. For another example, if an important incident happened in the operation system, the icon appended on the administration interface of the web page points to a special web page, which includes solution and analysis of the important incident.

In step S6, the icon displays color after appending the link to the icon. The color icon is arrestive to remind the user the unnormal status exists in the operation system. In step S7, the web page sending module 13 sends the web page appended the icon to the HTTP clients 2. In step S8, the user receives the web page via HTTP clients 2 and chooses the icon on the web page. In step S9, the icon appending module 12 executes a special function linked to the icon or opens a special web page includes solution and analysis. The special function and the special web page help the user to solve the unnormal status of the operation system.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for prompting unnormal statuses of an operation system comprising a HTTP server, the HTTP server comprising:
a request receiving module for receiving a request for reading the administration interface of the web page;
a detecting module for detecting an operation system and determining whether any unnormal status exists in the operation system;
an icon appending module for invoking and appending a corresponding icon on the administration interface of the web page according to the unnormal status, and for appending a link to the icon; and a web page sending module for sending the web page.

2. The system as claimed in claim 1, wherein the link points to a special function or a special web page, which is used for solving a problem resulting in the unnormal status.

3. The system as claimed in claim 2, wherein the icon appending module is further used for executing the special function or the special web page to solve the problem resulting in the unnormal status.

4. The system as claimed in claim 4, wherein the request receiving module is further used for opening the administration interface of the web page according to the requests.

5. A method for prompting unnormal statuses of an operation system, comprising the steps of:
receiving a request for reading an administration interface of a web page;
opening the administration interface of the web page;
detecting an operation system and determining whether any unnormal status exists;
appending a corresponding icon on the administration interface of the web page according to the unnormal status if such unnormal status exists;
appending a link to the icon, wherein the link points to a special web page or a special function; and
sending the web page.

6. The method according to claim 5, further comprising the steps of: choosing the icon; and executing the special function or opening the special web page.

7. The method according to claim 5, further comprising the step of displaying color icon after appending the link to the icon.

8. The method according to claim 5, wherein the step of determining whether any unnormal status exists comprises the step of ending the procedure if no unnormal status exists.

9. The method according to claim 5, wherein different icons show different appearances according to unnormal statuses.

10. The method according to claim 5, wherein the special function or the special web page is used for solving a problem resulting in the unnormal status.
